(19) United States
(12) Patent Application Publication
(10) Pub. No.: US 2017/0250550 A1
(43) Pub. Date: Aug. 31, 2017

(54) STANDALONE ADAPTER FOR LOAD CONTROL OF ENERGY STORAGE DEVICES

(71) Applicants: Valery Miftakhov, San Carlos, CA (US); George Betak, Palo Alto, CA (US)

(72) Inventors: Valery Miftakhov, San Carlos, CA (US); George Betak, Palo Alto, CA (US)

(21) Appl. No.: 15/444,325

(22) Filed: Feb. 27, 2017

Related U.S. Application Data
(60) Provisional application No. 62/300,073, filed on Feb. 25, 2016.

(51) Int. Cl. H02J 7/00; B60L 11/18

(52) U.S. Cl. CPC H02J 7/0026; H02J 7/0068; B60L 11/1838; B60L 11/1818; H02J 2007/0096

(57) ABSTRACT

A system, method, and apparatus for a standalone, mobile adapter for load control of energy consuming/storage devices. Adapter includes a power management module (“PMM”) that generates a simulated power control signal (“PCS”) with a reduced allowable power consumption, compared to an authentic PCS from electric vehicle service equipment (“EVSE”) power supply. An internally or externally controlled switch coupled to the PMM, selectively replaces the authentic PCS with the simulated PCS and communicates it to the load, thereby reducing the load's ability to draw power. The simulated PCS can be controlled and managed remotely by the user, and/or by an aggregating load server to provide value to the EV consumer, and stability and load-levelling to the power grid. Adapter includes functions of metering/measuring energy, regulation of energy consumption, direction of energy flow, safety monitoring, reporting of energy transfer, and location identification.

### CROSS-REFERENCE TO RELATED APPLICATIONS

This application claims priority to provisional application: Ser. No. 62300073 filed 25 Feb. 2016, entitled “STANDALONE ADAPTER FOR LOAD CONTROL OF ENERGY STORAGE DEVICES”, the disclosures of said application is incorporated by reference herein in its entirety.

Furthermore, where a definition or use of a term in a reference, which is incorporated by reference herein, is inconsistent or contrary to the definition of that term provided herein, the definition of that term provided herein applies and the definition of that term in the reference does not apply.

### FIELD OF TECHNOLOGY

The disclosed embodiments relate in general to the field of electric charging technology for energy storage or for electric vehicles. It also relates to the field of power grid management and, more specifically, to systems and methods for managing loads and energy storage for improved power grid performance.

### BACKGROUND

Electric Vehicles (“EVs”) and other energy storage and energy consuming devices typically plug into commercial or residential outlets with a 115V nominal voltage (e.g., single-phase) or a 230V nominal voltage (e.g., a split phase). Frequently, specialized EV service equipment (EVSE) is fixedly installed at a location because one or more EVs have a pattern of charging at that location. This would include home and work locations, as well as remote locations such as shopping malls, stores, and travel routes, e.g., along an interstate highway for long distance trips, just to name a few.

In a residential EVSE installation, the residents are typically the only users that consume power from the charger. Consequently, there are no separate billing provisions for the charger that would be separate from the single utility account for the single electric meter of a home. Alternatively, if there were a separate meter for the EVSE, then the separate meter would not bill for different users, because they would all be under the same household. This is satisfactory, as the resident is typically, the only person consuming power at their residence.

In situations where a commercial EVSE (charger) is used, i.e., outside the EV owner's home, a payment apparatus is typically provided for buying electricity. For example, a credit card, or other payment entry system is provided to bill the consumer for a discrete electrical consumption. However, the rate at which the user is billed for power can be vastly different from the rate the user would have been charged if they consumed power at their residence. This is because the commercial charging station may be in a different grid or subgrid, it may have a different electrical cost structure, or it may be under an entirely different service provider, with different costs of energy generation and distribution. In the commercial EVSE scenario, the users are independent consumers, and the EVSE charger is usually owned by a commercial company that installs, maintains, and manages the charging facility. Naturally, the commercial EVSE will earn a profit for their services and for their risk.

If an EV user were visiting a residence owned by another person who did not have an EVSE (charger), then power for his or her EV would typically be provided by a 115V household electrical outlet without a capability to measure the energy consumed. If these occasions are rare, then the power consumption may not be substantial. However, the owner of the residence may still want to be credited.

Most EVSEs have some minimal safety features, such as ground fault detection, to protect the user and the vehicle. However, many EVSEs may not have sophisticated or multi-mode safety logic beyond a ground fault detection. And if the EVSE does not have a redundant safety feature, i.e., two of the same type of safety circuits in a back-to-back arrangement, then a failure in the given safety function could result in a serious hazard. Furthermore, if a new safety feature is desired for a legacy EVSE installation, it might require removing and replacing the entire EVSE unit, though only a small fraction of the EVSE needs the upgrade.

Occasionally, an EVSE will have a power meter to indicate the power being consumed by the EV. In other instances, a house may have a fixedly installed electric supply that can be managed to reduce selective loads of the building under certain circumstances, e.g., a brownout. However, if this managed power supply is hard wired into the facility or if it applies a power reduction scheme on a building-wide basis, then any electrical load that is temporary, transient, or not planned, might not fit into the overall load management of the facility. For example, if a homeowner has a fixed wiring arrangement with non-essential loads on a first circuit whose power can be selectively reduced or eliminated, and with essential loads on a second circuit, whose power is not selectively reduced, then a visitor with an EV that is charging on the second circuit may not be selectively regulated. In addition, similar to the safety scenario, if a legacy EVSE does not have programmable features, then it might require removing and replacing the entire EVSE unit to gain the programmable features, though most of the EVSE is operating satisfactorily.

Grid operators typically predict and map the load being drawn for given subgrids and neighborhoods, then provide sufficient transformer resources and infrastructure to support those loads. This ensures adequate power generating and transmission capability for a given neighborhood. If substantial transient loads are introduced to a neighborhood that is incapable of handling them, then a local overload condition can arise, even though a grid overload condition would not arise. Moreover, if the power distribution company has no notice of these transient conditions, then they are unable to predict them, manage them, or mitigate their effect. Furthermore, if a given grid or subgrid has a flat rate structure, then consumers within the given subgrid or the entire grid are controlled homogenously vis-à-vis the power company, with no opportunity for individual tailoring, trading, or compensating in an intra-nodal, or intra-subgrid basis. In other words, individual power consumers or power producers deal only with the power company itself, via their single household meter and perhaps an optional dedicated EV meter, on a grid-wide basis.

### SUMMARY

An apparatus, method and system is disclosed, relating to a standalone adapter (the “Adapter”) for load control of energy storage devices, namely for managing power transferred between a power supply and a load.

In one embodiment, the adapter apparatus includes a power management module (“PMM”) that generates a simulated control signal that can replace an authentic control signal normally generated from electric vehicle service equipment (“EVSE”) power supply. A switch coupled to the PMM is controlled internally or externally to selectively replace the authentic control signal with the simulated control signal from the PMM. The simulated control signal can be wirelessly managed and controlled remotely by the user, or by an energy aggregator and manager in order to provide value to the EV consumer, and to provide stability and load-levelling to the power grid. The standalone adapter includes functions of measuring and/or metering energy, regulating energy consumption, selecting a direction of energy flow (charge or discharge), safety monitoring and reporting, reporting of energy transfer, and identifying its location, among other functions. The adapter is transparent to both the energy storage device, e.g., an EV, and the power supply, e.g., the EVSE.

The apparatus is selectively coupleable to the power supply and to the load, such as an electric vehicle (“EV”) or other energy storage device, whether it be battery, flywheel, pumped-hydro-storage, thermal storage, etc. The selective coupling feature of the adapter allows it to be optionally inserted between a charging source and an energy storage device, e.g., an EV energy consumer needing a recharge. The adapter can thus be slaved to a given EV as the EV travels from destination to destination. Moreover, the charging profile for the given adapter can be tuned depending upon geographical location, time of day, need of the user, and other factors, all of which can be selectively managed by the user, or relinquished by the user to a service provider or to a manager of aggregated users. The adapter can be shared across multiple vehicles belonging to a given user, or billing account. The adapter also has optional billing information for the owner/user of the adapter. Thus, an EV can charge at non-commercial sites that do not otherwise offer billing options.

The apparatus is designed to appear like a load, e.g., an EV interface, to the power supply, e.g., an EVSE. Thus, the adapter would include protocol equipment needed to operate the EVSE just as an EV would. Similarly, the adapter is designed to appear like a power supply, e.g., an EVSE, to the load, e.g., the EV. In this manner, the adapter is a transparent device positioned in situ between the power supply and the energy storage, or energy consumer device. Nevertheless, the adapter uniquely provides one or more layers of control and management hierarchically on top of, or in series with, the basic function of transferring power between the power supply and the energy storage, or consumer device. Thus, the adapter instantly transforms any unmanaged/legacy power source into a managed power source, whether it is a standard 115V kitchen outlet, a dedicated smart or dumb EVSE at home or work, or a commercial EVSE. Thus, the adapter can be used in series with a commercial EVSE in order to control the charging remotely.

For power sources that already have power management features, the adapter can still provide a higher level, redundant, or overriding level of noted functions. Hence, if an EV user connects to a commercial charging station, then there is still value to having the adapter sit on top of both the EVSE and the EV. Assuming that the commercial charging station regulates and bills the user seamlessly, and provides state-of-charge (SOC) and other metrics of the traction batteries being charged to the EV user via an EV mobile application, then there are still additional features that the adapter offers. First, the adapter can provide backup safety features, on top of those provided by the EVSE, even if the adapter is in a stand-down mode where it does not actively control anything during the energy transfer. Second, if the adapter is active during the energy transfer, then it can act as a second, redundant, layer that selectively reports the metrics described earlier and can selectively control or override said power regulation. For example, if a user selects a fast charge with premium pricing from a commercial EVSE because of an urgent trip that requires additional range, but then later the urgency is downgraded while the EV is still charging, then the user can remotely program the adapter to reduce power consumption. This is done by internally generating a signal in the adapter, sending the signal to the EVSE to draw a smaller amount of current to the battery, and thus the EV will reduce its power draw from the EVSE. This is accomplished in one embodiment by the adapter generating a signal indicative of a full EV battery. Thus, adapter acts as a serial regulator/controller of charge current downstream of the EVSE and upstream of the EV load.

The Adapter is also controllable remotely via a module and a server-based system to manage loads and energy storage for improved power grid performance and thus increased value to the user of the Adapter.

The methods, operations, processes, systems, and apparatuses disclosed herein may be implemented in any means for achieving various aspects, and may be executed in a form of a machine-readable medium, and/or a machine accessible medium, embodying a set of instructions that, when executed by a machine or a data processing system (e.g., a computer system), in one or more different sequences, cause the machine to perform any of the operations disclosed herein.

Other features and advantages of the present disclosure will be apparent to those of ordinary skill in the art from the accompanying drawings and from the detailed description of the preferred embodiments that follows. Accordingly, the specification and drawings are to be regarded in an illustrative rather than a restrictive sense.

### BRIEF DESCRIPTION OF THE VIEW OF DRAWINGS

Example embodiments are illustrated by way of illustrations and are not limited by the figures of the accompanying drawings, wherein:

FIG. 1 is an energy system including energy generation, distribution, consumption, and demand/response management, according to one or more embodiments.

FIG. 2A is a block diagram of a system using standalone adapter for load control of energy storage devices, according to one or more embodiments.

FIG. 2B is a block diagram of a system using a wireless standalone adapter for load control of energy storage devices using inductive charging, according to one or more embodiments.

FIG. 2C is a circuit schematic of a vehicle simulator portion of the standalone adapter for load control, according to one or more embodiments.

FIG. 3 is a functional block diagram of load server modules operated on a load server for demand/response management between the power grid and a standalone adapter for load control, according to one or more embodiments.

FIG. 4 is a mobile device with a graphical user interface for demand/response management of a standalone adapter for load control, according to one or more embodiments.

FIG. 5 is a graph of a time-based power consumption profile for a power grid, according to one or more embodiments.

FIG. 6A is a flowchart of a method for operating the standalone adapter for load control, according to one or more embodiments.

FIG. 6B is a flowchart of a method to aggregate and manage multiple standalone adapters for load control vis-à-vis power grid real-time price and demand metrics, according to one or more embodiments.

FIG. 7 is a block diagram of a computer system for implementing the load server modules using the method for aggregating and managing multiple standalone adapters for load control vis-à-vis power grid real-time price and demand metrics, according to one or more embodiments.

FIG. 8 is a plot of a geographical redistribution of power generation/consumption profiles having intra-nodal power management capability from the load server modules on the multiple standalone adapters, according to one or more embodiments.

FIG. 9 is a graph of redistribution of power consumption based on time-of-day metrics, using the standalone adapters, according to one or more embodiments.

FIG. 10 is a graph of different duty cycles for generating a power control signal to manage power usage, using the standalone adapters, according to one or more embodiments.

The drawings referred to in this description should be understood as not being drawn to scale, except if specifically noted, in order to show more clearly the details of the present disclosure. Same reference numbers in the drawings indicate like elements throughout the several views. Other features and advantages of the present disclosure will be apparent by reference to the detailed description when considered in conjunction with the figures.

### DETAILED DESCRIPTION

An apparatus, method and system is disclosed, relating to a standalone adapter for load control of energy storage devices, and a module and server-based system for managing multiple instances of said standalone adapters for balancing/regulating loads and energy storage for improved power grid performance. In the following description, for the purposes of explanation, numerous specific details are set forth in order to provide a thorough understanding of the various embodiments. It will be evident, however to one skilled in the art that various embodiments may be practiced without these specific details.

### Energy System:

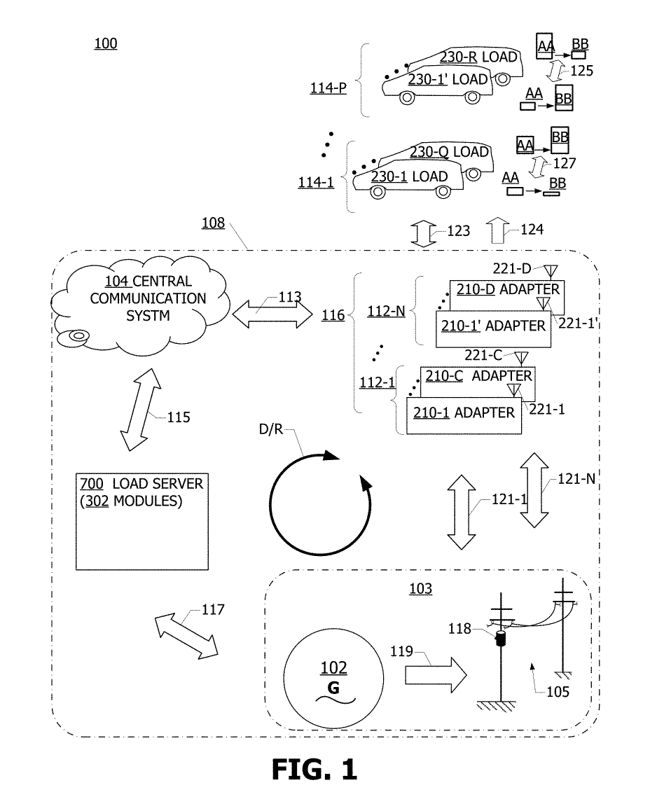

Referring now to FIG. 1, an energy system 100 is shown that includes energy generation, energy distribution, energy consumption, and energy demand/response management, according to one or more embodiments.

Energy system 100 includes a power generator 102 (“G”) that is electrically coupled 119 to a power distribution network, or infrastructure, 105 (together referred to as the “power grid” 103). The distribution network 105 includes subgrid, topology nodes, and other forms of hierarchical distribution of power, via transformers, and other distribution equipment that then transfer power at distributed points 121-1 to 121-N, to loads interface 116, grouped as interface clusters, e.g., 112-1 to 112-N, for their respective node in the grid. Notably, while it is important for the entire grid to be balanced and regulated, i.e., for grid load to not exceed grid power generation, it is likewise important for each node to be balanced and regulated, i.e., for the load on a given node to not exceed the capacity of the node transformer. That is, a grid can be balanced overall, while still having one or more nodes that are overloaded, and thus a problem, while other nodes that are underloaded, and not a problem. Interface clusters 112-1 to 112-N are comprised of intermediate controls, e.g., adapters 210-1 to 210-C and 210-1′ to 210-D, respectively, that sit between the power distribution network 105 and the load clusters 114-1 to 114-P. Load clusters 114-1 to 114-P in turn include the ultimate loads 230-1 to 230-Q, and 230-1′ to 230-R, respectively, which are EV batteries for energy storage in this embodiment. Adapters 210-1 to 210-C and 210-1′ to 210-D, have wireless capability via antenna 221-1 to 221-C and 222-1′ to 222-D for external and remote control. Variables A, B, C, D, N, P, Q and R are any positive integer.

In the present embodiment, the demand/response aspect allows communication from load interfaces 116 via communication 113 to central communication system 104, e.g., via the Internet cloud, which can then subsequently provide communication 115 to a load server 700, which is then communicatively coupled 117 to the power grid 103, including power generation 102. In this manner, the D/R environment 108 provides a closed loop, with feedback. The benefit here is that mobile loads are now accountable and regulatable based on telemetric and chronological basis. Thus, for loads 230-1 thru 230-Q and 230-1′ thru 230-R power consumption levels are hypothetically modified from AA to BB, respectively, based on noted factors of demand, grid capacity, and the location, time, level of need, price willing to pay, etc. The result is a rearrangement of power consumption within a load cluster 114-P or between load clusters, e.g., 114-1 to 114-P.

Using the present disclosure, information on power demand can be predicatively and apriori estimated using actual user historical and real-time input along with algorithmic techniques such as Kalman filtering, and other predictive models.

### Standalone Adapter:

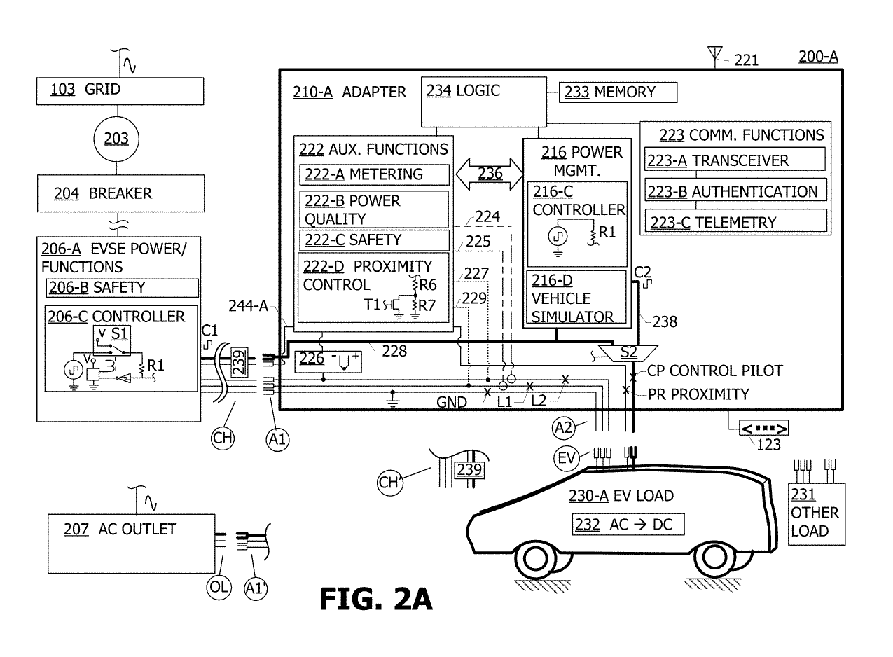

Referring now to FIG. 2A, a block diagram is shown of a system using a standalone adapter for load control of energy storage devices as in a system 200-A, according to one or more embodiments.

Power is supplied from grid 103 through meter 203 and breaker 204 to EVSE power and functions equipment 206-A, aka power supply, in which an optional safety module 206-B and a controller 206-C are used to provide and regulate power to a load. Controller 206-C is an exemplary Society of Automotive Engineers (SAE) J1772 EVSE controller in the present embodiment, with proximity switch S1. However, any configuration of controller 216-C is possible with the present disclosure, providing the vehicle simulator 216-D matches the expected circuit performance for a given charging standard. In lieu of a specialized EVSE 206-A, a standard household AC outlet (OL) 207 can be used to power EV load 206-A via adapter 210-A. The EVSE 206 also has an SAE compatible charge interface CH, which has a ground line and two power lines, corresponding to lines GND, and L1-L2 lines, respectively, in adapter 210-A. The EVSE 206 also has a proximity line and a power control line, or control pilot, (together 239) that correspond to lines 244-A/PR and 228/CP, respectively, in adapter 210-A.

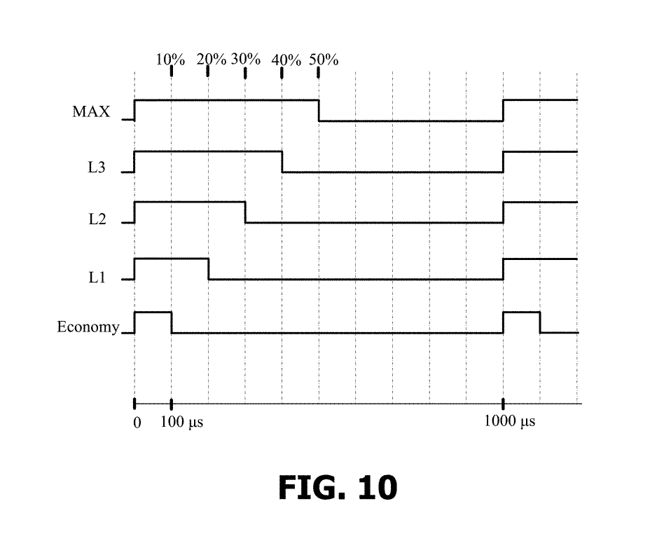

Power control line output from EVSE 206-A outputs a power control signal C1 as a 1 kHz square wave whose pulse width modulated (“PWM”) duty cycle represents a maximum allowed mains current, which said power control signal is communicated to the load so the load. The amperage capacity (“ampacity”), which is the maximum amount of electric current the device is determined to accept, is defined by a formula based on a 1 ms full cycle of the 1 kHz signal. Consequently, the maximum continuous ampere rating is 0.6 A per 10 μs (with the lowest 10% PWM yielding 100 μs and giving 6 A, while the highest 80% PWM yielding 800 μs and giving 48 A. More detail is found in the publication “SAE J1772—SAE Electric Vehicle Conductive Charger Coupler”, August 2001, Appendix A, Typical Pilot Line Circuitry, which is incorporated by reference herein. A graph of the different duty cycles is presented hereafter in FIG. 10. Again, any interface can be used such that adapter 210-A is designed to be compatible with the known interface.

The standalone adapter (apparatus) 210-A manages power transferred between a power supply, EVSE, 206 and a power consumer, i.e., EV load 230-A. Adapter 201-A comprises a power input port A1 for receiving power from the power supply; a power output A2 port for transferring power from the power input port to the load via one or more internal power lines L1-L2. Adapter 201-A further comprises a ground line (GND), an output control line (control pilot, CP) for communicating a power control signal C1 or C2 to the load, and a power management module (“PMM”) 216 coupled to the output control line CP. Both power control signals C1 and C2 indicate a quantity of power (amps) available for the load. The PMM 216 is configured to manage the output control line CP. The adapter 210-A is selectively coupleable at A2 and A1 respectively, to the power supply 206-A and to the load EV 230. Within EV load 230, an AC to DC rectifier 232 provides DC current to traction batteries for charging. Alternative loads 231 other than an EV can use the same philosophy of a full-duplex handshake protocol for connecting and regulating power and turning power on and off. The adapter 210-A further comprises a plurality of intermediate control lines 238, 228, each of which carries a respective power control signal C1 and C2. Additionally, adapter 210-A comprises a switch S2 coupled to the plurality of supply control lines C1 and C2, said switch configured to output onto the output control line CP, only one of the power control signals C1 or C2. A selector signal is input to switch S2 from auxiliary functions block 222, and in different embodiments can be sourced locally from logic 234, or can be provided wirelessly via transceiver 233-A, antenna 221. If sourced externally, selector signal is driven by either load server module 700 of FIG. 1, or a user interface on a mobile device, such as a cell phone, as shown in a subsequent figure.

The plurality of intermediate control lines includes a first intermediate control line 228 coupled to the power supply 206-A to receive a first power control signal C1 having a first priority level. A second intermediate control line 238 is coupled to the PMM 216 to receive a second power control signal C2 generated by the PMM and having a second priority. The first priority level and the second priority level can be different levels, and typically are different to provide a plurality of different control signals, formats, or patters from which to select. In other embodiments, the priority levels are the same level (when the external control provides approval to charge at the full rate of the power supply). Control signal C2 is generated in the same manner as the C1 control signal, which is per the SAE J1772 specification (or whichever specification is desired for a given application). Specifically, the C2 signal is generated for the desired power rate, or ampacity, per the user/load server instruction. As an example, if an EV battery were rated to accept 30 A, then the EVSE would generate a power control signal C1 of 50% duty cycle, for 30 A. On the other hand, the user or the load server might want the EV battery to accept only 6 A, or ⅕^{th} of the rate it could accept, because of peak grid usage at the location of the adapter and the time of charging. In this scenario, C2 signal generated by controller 216-C in PMM 216 would have a 10% duty cycle, for 6 A. Switch S2 would select the C2 signal and sink the C1 signal into vehicle simulator 216-D, thus communicating only the C2 signal of 10% duty cycle, at 6 A, or ⅕^{th} of its maximum rate, to the load 230. Thus, second power control signal C2 can effectively overrides the default, first power control signal C1 in a manner very transparent to both load 230-A and EVSE 206-A.

The PMM 216 comprises a controller 216-C coupled to a second intermediate control line 238. The PMM is configured to receive an instruction, via antenna 221 and transceiver 223-A, that was generated externally from adapter 210-A. The instruction indicates a desired quantity of power to be made available from the power supply to the load. Controller 216-C implements the instruction by generating an internal power control signal C2, which is a square wave in this embodiment and which is representative of the desired quantity of power to be made available for the load. The PMM 216 is configured to generate internally a replacement power control signal as an artificial maximum power available from the power supply to match the instruction received, which in turn is based upon a demand/response (“D/R”) signal 113/117 of a power grid 103, e.g., a smart grid, to which the power supply is coupled. The switch S2 is configured to: receive an instruction to its selector line to bypass the PMM and to pass-through the first power control signal from the first intermediate control line directly to the load.

Adapter 210-A is a self-contained modular device in one embodiment. Adapter 210-A also includes one or more ammeters 224 or 225 coupled to the internal power line to measure current consumed over a given period of time. Additionally, adapter 210-A includes a transceiver 223-A, coupled to the PMM 21, that is either wired for static applications (via bus 123, or alternatively CAT5 Ethernet) or is wireless via antenna 221 for wireless applications. Wireless transceiver 223-A is configured to communicate status data between the adapter 210-A and an external node and to receive an instruction from the external node to regulate the output control line CP. A telemetry module 223-C identifies a location of the adapter 210-A for purposes of monitoring or controlling power node consumption (where adapter is located) to manage power consumers/suppliers that are mobile or transient. Thus, while smart meters work for stationary installations, a transceiver is needed for loads that geographically move, because it will draw from the power grid at different transformers, subgrids, subnodes, or etc. Consequently, a mobile load may charge at 100% in a low power usage subgrid, and after driving to a high usage subgrid, or charge at a peak usage of the day at which point and time, the adapter may only allow a base charge rate of only 10%, unless prioritized for a premium rate. Additionally, adapter 210-A includes a safety module 222-C coupled to the PMM 216. Safety module 222-C is configured to evaluate one or more performance metrics and to disable, derate, or impede, the power source 206-A, e.g., by shutting down C2 control signal via logic 234 coupled to memory 233 (for storing data, parameters, and instruction code), if a performance metric is outside a safe range or level. Performance metrics can be voltage, current, power factor (“PF”), temperature, power quality, etc. A temperature meter 226 is coupled to the PMM 216 via safety module 222-C, and wherein the temperature meter measures a temperature of at least one of an internal power line L1-L2, a power inlet A1 and a power outlet A2). A power quality module 222-B is also disposed in adapter 210-A which senses a quality level of at least one of a measured current 224, 225 and a measured voltage 227, 229 of the power received from the power supply 206-A. Power quality module 222-B communicates the quality level to the PMM 216 via logic 234, and PMM 216 adjusts a second power control signal C2 based on the quality level. The power quality module reduces power consumption if the quality level indicates an overload of a local distribution transformer.

In different embodiments, adapter 210-A is slideably, directly or inductively coupleable (A2, A1 respectively) to power supply 206-A and load 230 and is disconnectable, interconnectable, insertable/removable from same as a transportable mobile component. Adapter 210-A is capable of interfacing with a plurality of different power supplies; is self-powered; and does not require a separate external power source to operate in the present embodiment. The respective input control signal on each of the plurality of input control lines can be a different value. The switch is configured to pass the first power control signal through to the load as a default, in one embodiment. In another embodiment, switch is configured to prioritize communicating the second power control signal and not the first power control signal to the load. (the control line is slated to the PMM). The desired quantity of power is based on formula of grid status alone or in combo with load status. Adapter 210-A can also be integrated into a fixed EVSE in one embodiment.

A voltmeter is disposed in the adapter for measuring voltage, and in connection with ammeter measurements, is used for measuring power and energy consumption. Metering module 222-A, in aux functions block 222, provides local control of metering power to be compliant with the desired power control signal. Thus, metering module 222-A is a redundant system beyond a metering function built into EVSE 206-A unit. This information is communicated from adapter 210-A to central communication system 104 and back to utilities with a user ID provided by adapter 210-A for remote and mobile submeter billing to the appropriate consumer.

Proximity control block 222-C contains circuitry transistor T1 and resistor divider R6, R7 to simulate the same proximity control normally found in the EV load 230, i.e., the EVSE connector per a given charging standard, e.g., SAE J1772, which is hereby incorporated by reference. Electronically controlled transistor T1 simulates a manual switch S3 in the SAE EVSE connector schematic. Vehicle simulator block 216-D is described in a subsequent figure. Communication function block 223 comprises a transceiver 223-A coupled to authentication block 223-B and to telemetry block 223-C. Authentication block uses any number of encryption and authentication protocols to ensure the user identity or the load server identify. Telemetry module 223-C utilizes any one of a number of telemetry protocols and equipment such as global positioning system, aka radio signal trilateration, and such as triangulation, e.g., using cellular phone base stations.

Referring now to FIG. 2B, a block diagram 200-B is shown of a system using a wireless standalone adapter for load control of energy storage devices using inductive charging, according to one or more embodiments. System 200-B is similar to system 200-A, except for two main differences. First, power control signal C1 and proximity signal are both communicated wirelessly from EVSE 206-A′ via antenna 246, which communicates to antenna 221 of adapter 210-B. Secondly, and similarly, wireless inductive charging rather than direct connection charging from EVSE 206-A′ to load, is illustrated in the present embodiment, as inductive coils 240-1 and 240-2 for EVSE 206-A′and as inductive coils 242-1 and 242-2 for EV load 230-B. A description of remaining blocks with common reference numbers is provided in FIG. 2A. Using inductive charging and wireless communication for control and proximity signals simplifies the charging process for an EV by removing the manual connection, and possible damage and operator errors caused by it. Optional antenna 248 on EV load 230-B can be used for communication on status of charging. Adapter 200-B also has a touch input/output (I/O) capability for direct manual operation.

Referring now to FIG. 2C, a schematic is shown of a vehicle simulator portion of the standalone adapter for load control, according to one or more embodiments. Vehicle simulation schematic 216-D is a slightly modified schematic of that the circuit required for a given charging protocol, this embodiment for the SAE J1772 charging protocol for vehicle controller. An added transistor T2 provides a switching capability that can draw down power away from the controller. By providing a vehicle simulator circuit 216-D in adapter 210 (i.e., 210-A and 210-B), the power control signal from EVSE 206-A can receive and sink, thus making adapter 201-A transparent to controller 206-C of EVSE 206-A′.

### Load Server System:

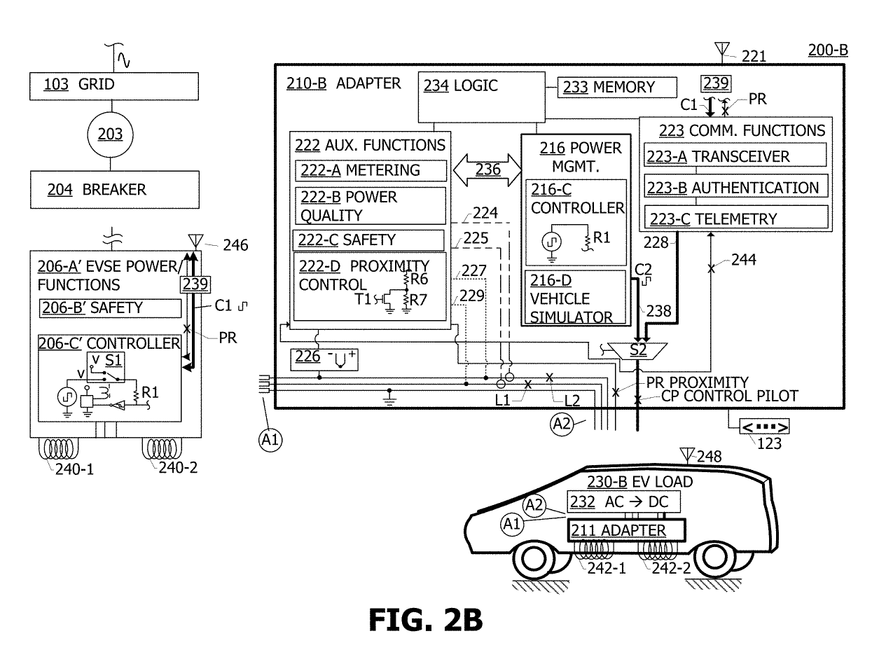

Referring now to FIG. 3, a functional block diagram is shown of load server modules 302 operated on a load server for demand/response management between the power grid and a standalone adapter for load control, according to one or more embodiments.

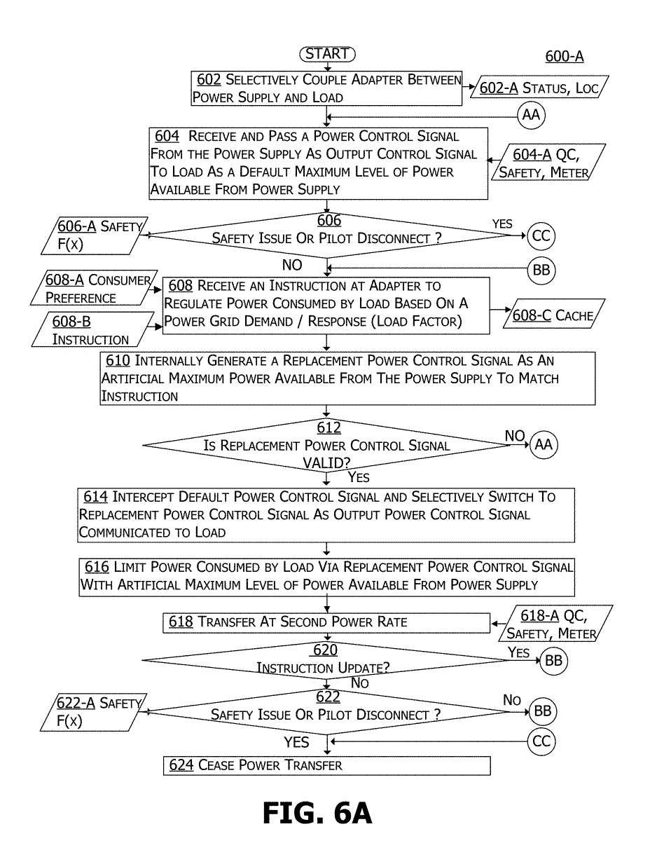

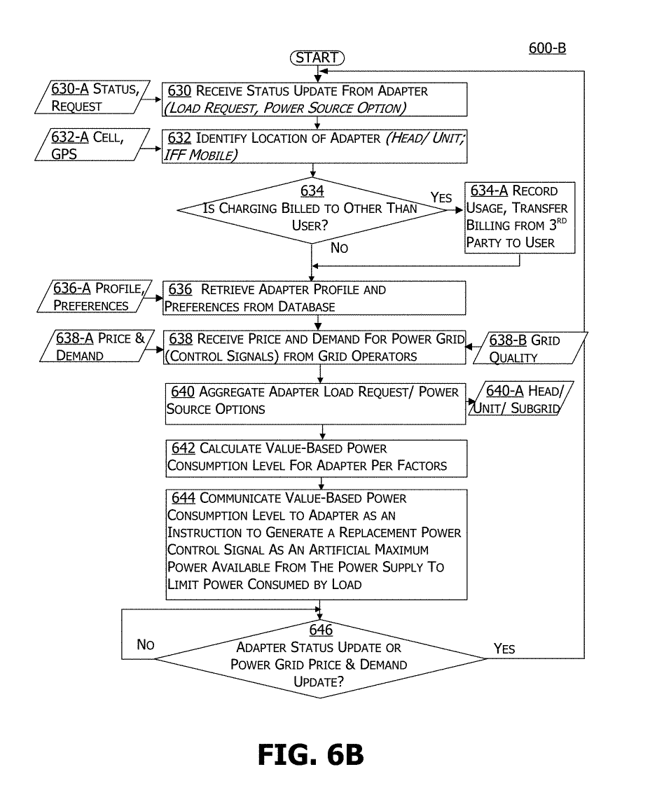

Load server module block 302 is used for managing power, and is executed on load server equipment 700 of FIG. 7, which is coupled to power grid 103 as shown in FIG. 1. Load server module block 302 includes a grid power module 304 configured to receive and sum data from multiple adapters based on their predicted power demands 304-A (based on historical) on the power grid, as per step 638-A of FIG. 6B. Further, grid power module 304 is configured to receive and aggregate the grid quality feedback signals 304-B based on the power consumed by the one or more power consumers as reported by their adapters. Quality level operations 638-B, 604-A of FIGS. 6A, 6B include at least one measurement/metric of a current 227, 229 and a voltage 224, 225 of FIG. 2A and can be any form of power or component thereof, such as voltage spikes, noise, varying power factor, overvoltage, undervoltage, arc fault, frequency drift and jitter, etc. (together “Metrics”). Grid predictions and grid quality can be aggregated and mapped geographically, similar to that for input 306-B below, using feedback from one or more adapters.

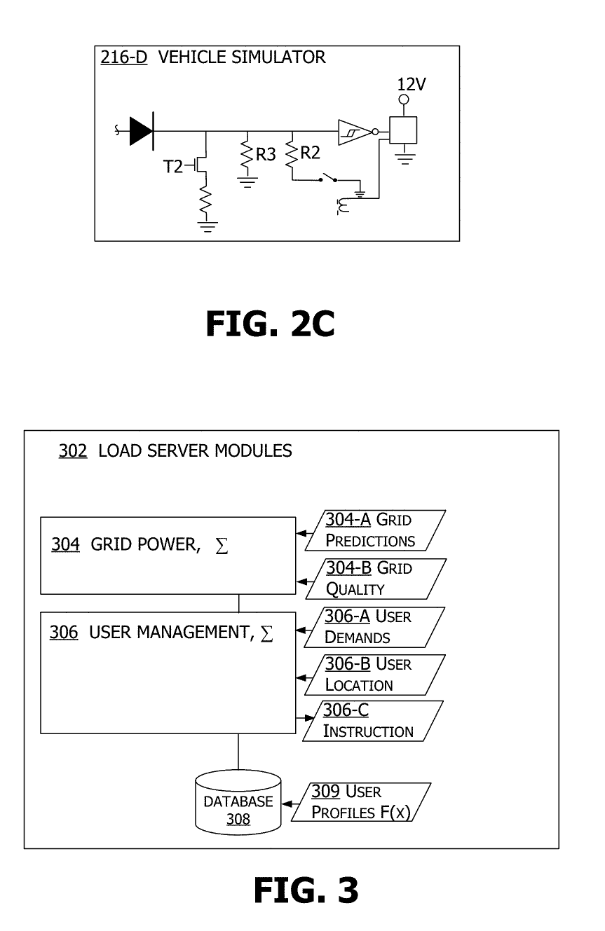

Load server module block 302 also includes a user management module 306 configured to generate an instruction 306-C for managing power consumption, aka load control, to be executed by one or more adapters that are disposed between the grid and the load, e.g., load 230. User management module 306 is coupled to database function 308, which is executed on physical hardware 712, and is coupled to the communication interface 714, the grid power module 304, and the user management module 306. Load server 700 is configured to transmit the instruction to a power management module (“PMM”) 216 of FIG. 2A which is coupled to a load, e.g., 230-A. By using load server modules 302, the PMM 216 is configured to manage an output control line CP indicating a quantity of power available for the load, and to transmit to the power consumer a plurality of choices for power consumption levels 406, 408, and 410 shown in FIG. 4.

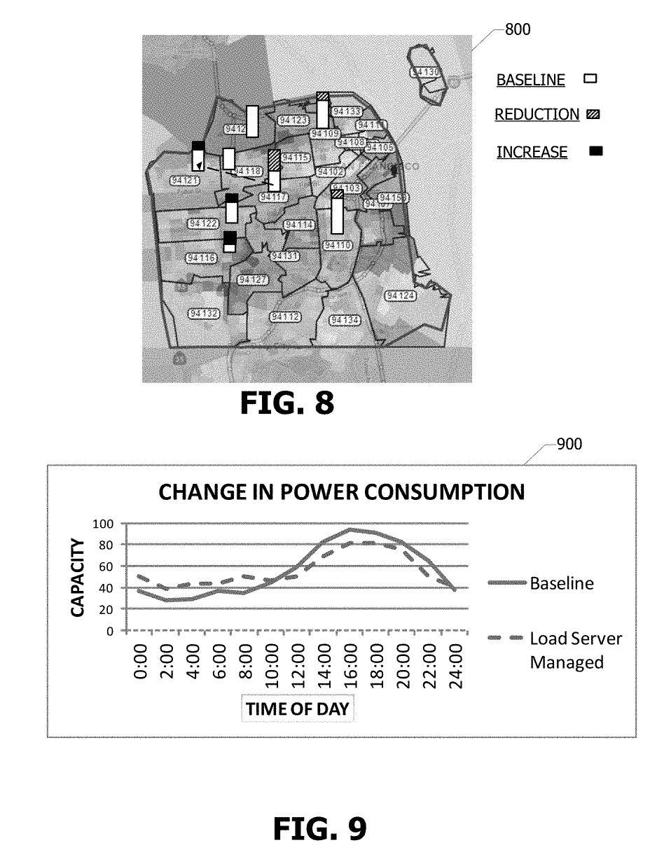

User management module 306 is further configured to receive location information 306-B and an actual power demand 306-A from the one or more power consumers, e.g., load 230, coupled to the power grid. The power demand from the plurality of power consumers, e.g., from interface clusters 112-1, 112-N is mapped with the location information, as shown in FIG. 9 to one or more topology nodes of FIG. 9, e.g., zip code 94117 within the distribution network, or infrastructure, 105 of the power grid. User management module 306 can also be used to manage power consumption by regulating the one or more loads via interfaces 121-1, 121-N on the power grid with transmitted instructions to the power consumer, which are executed on adapter 210-A.

The load server module 302 is further configured, in one embodiment, to manage via user demand module 306-A a submeter power consumption by the power consumer as recorded by module 222-A. This submeter power consumption is then billed to the power consumer via an adapter ID.

Referring now to FIG. 4, a mobile device 400 graphical user interface (GUI) is shown for demand/response management of a standalone adapter for load control, according to one or more embodiments. Either adapter 210-A of FIG. 2A or load server 700 of FIG. 7 using load server module 302 functions can provide a wireless signal to mobile device 400 with the GUI shown to illustrate the state of charge (“SOC”) power meter 404 along with different power levels, e.g., conserve 406, average 408, high 410, time of day (TOD) needed 412, or power outage 416. Different price levels are associated with the different levels ranging from $ to $$$$. In this manner, a user can choose a desired charge rate (power level) with a tradeoff with budget. In another embodiment, processor and memory (not shown) in cell phone 400 can perform an algorithmic calculation of a charge rate needed (based on a state of charge forwarded from adapter 210-A, and set defaults for the user to make the decision more automatic and less intrusive. Alternatively, a user's preferences and settings can be centrally maintained in load server 700 (on the cloud) with an associated ID for the user. Either way, a user can remotely control power usage as a default, or on an event-by-event basis.

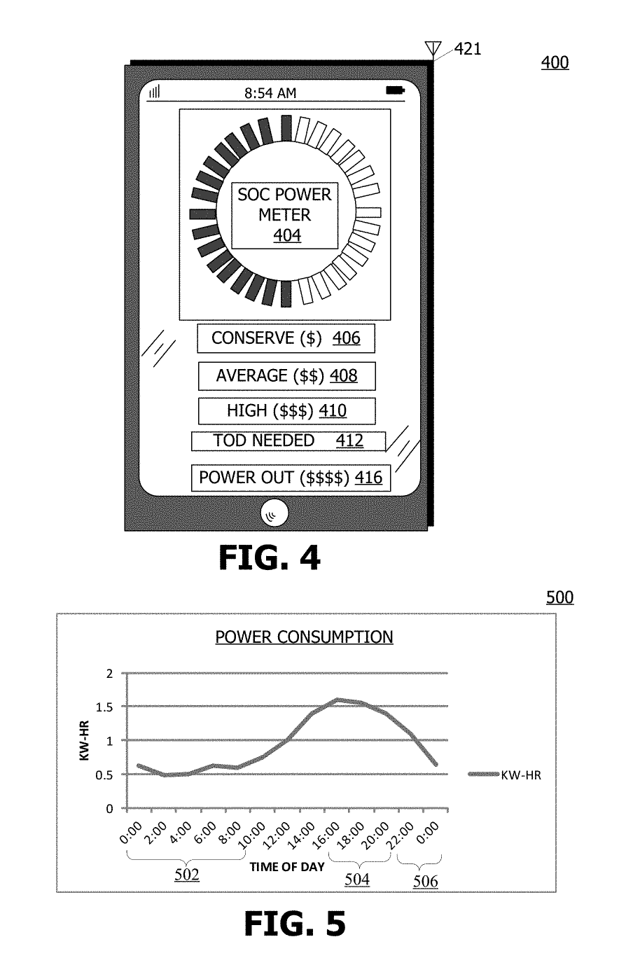

Referring now to FIG. 5, a graph 500 is shown of a time-based power consumption profile for a power grid, according to one or more embodiments. The KW-HR consumption of an average grid might appear something like the exemplary graph, with relatively flat usage time span 502 from midnight to 08:00 hours, and a gradual rise from 10:00 to 18:00 hours. Peak usage occurs around the hotter part of the day, per time span 504, being mid-afternoon on a sunny summer day, between 16:00 to 22:00 hours (from heavy air-conditioning loads). Thereafter, from ˜18:00 to midnight, consumption drops down linearly in time span 506. With TOD pricing, charging can be algorithmically timed as a default to charge in the more expensive during time span 502, with selective user-based decisions to charge in section 504 only when necessary. Moreover, a utility company may provide incentive pricing to curtail usage during time span 504, in which case, load server 700 can select those users who set their adapter with permission to allow a cessation or cutback of charging during certain time spans, such as time span 504. Load server 700 can aggregate via load server modules 302 said users and offer block pricing to power consumers, and substantial load reduction to power generator 102 and distribution infrastructure 105 of FIG. 1.

### Method:

Referring now to FIG. 6A, a flowchart 600-A is shown of a method for operating the standalone adapter for load control, aka managing power consumption, according to one or more embodiments. In general, the method of managing power to be transferred between a power supply and a load comprises operations for receiving power from the power supply at a power input port A1 of an adapter; transferring the power from the power input port to a power output A2 port via one or more internal power lines L1-L2). Operations also include receiving and communicating a power control signal to the load via an output control line CP), wherein the power control signal indicates a quantity of power available for the load to draw. This method effectively manages the power control signal via a power management module (“PMM”) 216 in an adapter 210-A of FIG. 2A, which is coupled to the output control line and which modifies the power control signal provided to the output control line.

More specifically, the method comprises the following operations. In operation 602, the adapter is selectively coupled between power supply 206-A and EV load 230-A. Prior solutions do not teach an intermediate adapter disposed between the EVSE and the EV load, wherein the adapter adds an only or a full or partial duplicate layer of control, metrics, safety, monitoring, or selectability to the user. Even if an EVSE might have some of these functions, the EVSE is still a static, non-mobile installation, and thus does nothing for the mobile loads that are intrinsic with, for exam-le, a mobile EV. Adapter 210-A of FIG. 2A initializes and enables a handshake protocol between the EV load 230-A and EVSE 206-A. At this point, output 602-A communicates a location and status of adapter 210-A and an indication of starting a charge operation to external load server 700 of FIGS. 1 and 7, and/or to a mobile device 400 of FIG. 4, as source from a telemetry module 223-C via antenna 221 or USB 123. The telemetry allows management of the mobile load regardless of where the load is located, even when it is outside of normal charging locations such as home and work. This avails the user to charge using rate plans that can follow a given user despite their location, e.g., out of network. And it allows the server to plan for grid load. Charge rate plans can include a base rate or incentives for not charging at peak times, or credit for feed-in to the grid during peak times as a power source for load balancing, etc. It also enables the load server to aggregate and influence a substantial quantity of mobile loads on the power grid from mobile users, such as EVs, which was previously not possible.

Optional operation 604 receives a first power control signal C1 having a first priority level from a first intermediate control line 228 coupled to a power supply. If the adapter is coupled to an EVSE power supply, then the EVSE typically provides a power control signal. Yet, even if there is a smart meter in the charging location, it still may not enable a third party to aggregate a block of power consumers to regulate their power consumption for either cost, conservation, or load balancing. If adapter 210-A is coupled to an AC outlet 207 of FIG. 2A, or to an EVSE without intelligent power control, then adapter 210-A provides the only means of regulation of the power drawn by the load. As a default embodiment, switch S2 in adapter 210-A of FIG. 2A receives an instruction, or a selector signal, to bypass an internal power control signal generated by PMM 216 and to pass-through the first power control signal on the first intermediate control line 228 directly to the load, e.g., EV 230-A. This is useful at initial connection when the power quality and needs of the user and the load are potentially unknown. A default maximum level of power is made available to the EV load in this embodiment, as normally established by the EV's on-board charging equipment and/or the optional EVSE or AC outlet.

In another embodiment for operation 604, a starting profile of a user is stored in memory 233 of adapter 210-A, along with predictive metrics, such as location, time and date, schedule, etc. In this manner, initial spikes in power consumption are curtailed while adapter 210-A initializes and settles on a charging plan. Said differently, if every EV power consumer was to plug in and start charging at the maximum rate while their adapter was converging on a charging plan, then that might be a substantial aggregated load on the power grid, which need not occur. In another embodiment, an artificial intelligence (“AI”) algorithm operating in logic 234 and memory 233, or in memory 712 of load server 700, communicates via transceiver 223-A with mobile device 400 to establish location, schedule, time, predictive grid loads, etc., and then suggests an initial charging scheme that can execute immediately, with the option for cancellation. As an example schedule, AI determined that a location of user, Mr. V, was outside of his normal commute path, that a distant scheduled appointment was pending for Mr. V, that a range of travel is immediately required to get across the Bay, and that a present battery state of charge was insufficient, and thus a maximum fast charging regardless of TOD and surcharges is required. This charging preference can be communicated by adapter 210-A to a commercial EVSE, along with payment information stored in memory 233, thus making the entire recharge operation transparent and seamless to user. Similarly, the opposite scenario is possible in another embodiment.

While adapter 210-A is plugged into EVSE 206-A, operation 604-A senses and evaluates a quality level (“QC”) of the power source, evaluates safety performance, and evaluates one or more performance, or metering, Metrics. This is accomplished at power quality module 222-B and at safety module 222-C of FIG. 2A in the present embodiment. This information is used in a later operation to regulate power consumption and to evaluate safety performance of the charging operation.

Operation 606 evaluates input 606-A whether any safety issue exists. If a safety issue does exist, then process is forwarded to operation 624, which ceases power flowing through adapter 210-A by either simulating a disconnect via interrupting the proximity signal to EVSE 206-A or by another means that would discontinue current transfer. Safety function includes evaluating measured parameters and indicating outliers, such as over temperature, over-voltage, over-current, etc. as provided by safety module 222-C of FIG. 2A.

If no safety issues exist, then operation 608 receives an instruction 608-B externally from the adapter, via antenna 221 and transceiver 223-A, indicating a desired quantity of power to be made available from the power supply to the load. The desired quantity of power can either be an input 608-A of a level selected by the user via mobile device 400 of FIG. 4, or an input 608-B from load server 700 of a level, or an input that is a hybrid combination of inputs from both the user and the load server. Output 608-C stores values in cache, such as memory 223.

In operation 610 a replacement, or internal, power control signal C2 is generated by controller 216-C in conjunction with logic 234, disposed in the adapter 210-A. The internal power control signal implements the instruction received from a user or a load server 700 and is representative of the desired quantity of power to be made available for the load. Internal power control signal C2 can be the same as, or different from, the power control signal C1 provided by EVSE 206-A, or it can be the only power control signal provided if the power source is AC outlet 207, which has no power control signal capabilities. Internal power control signal is an artificial, or faux, signal of the maximum power available from the power supply. Thus, by replacing the EVSE power control signal C1 with the internal power control signal C2, the adapter essentially modifies the incoming power control signal from the EVSE to a potentially different power control signal that is sent out to the load.

The second power control signal C2 received on intermediate control line 238 of FIG. 2A has a given priority, while the first power control signal C1 received on intermediate control line 228 has its own given priority, wherein the given priority of the first power control signal can be different than that of the second power control signal. The maximum power available to the load is attained by varying the duty cycle. In addition, power quality module 222-B can regulate control line via PMM based on the quality level sensed, or the power quality module reduces power consumption if the quality level indicates an overload, e.g, from electrical noise, of a local transformer 118 in a distribution network 105. In other words, if excessive voltage spikes are arising from power provided by EVSE 206-A, then power quality module 222-B might reduce the present charge rate of 30 A down to 6 A, in order to protect the battery integrity of the load 230-A. Thus, multiple charge rate controls can override each other, with a hierarchy of safety and charge quality overriding a preferred charge rate setting, all of which ultimately override, in that sequence, the EVSE chare control signal.

Operation 612 inquires if the replacement version of the power control signal is valid. Validity can be established based on authentication of user, resolution of conflict with load server settings, satisfactory software patch updates, etc. If not valid, then procedure returns to operation 604, which defaults to the EVSE power control signal C1.

If the replacement power signal is valid, then operation 614 intercepts the default (EVSE) power control signal and selectively switches out to the replacement power control signal C2 that was generated internally by controller 216-C. The plurality of power control signals C1, C2 on each of the plurality of intermediate control lines 238, 228, is communicatively coupled to switch S2 in FIG. 2A, which selectively switches between the plurality of intermediate control lines 228, 238 to communicate a given one of the plurality of power control signals to the output control line CP.

Operation 616 effectively limits the power consumed by the load via the replacement version of the power control signal with artificial maximum level of power available from power supply. The example provided in FIG. 2A above for duty cycle adjustment effectively illustrates how a derated maximum from the internal power control signal effectively reduces the power consumption by the load. Operation 620 proceeds to allow the transfer of power at the second power rate dictated by the second power control setting. Operation 620 inquires whether an instruction update has occurred, or simply responds when an instruction update is received at adapter from a user or load server. Operation 622 inquires whether a safety issue or pilot disconnects occurred. The description for operation 606 applies to operation 622 and is included by reference.

Operation 624 discontinues power transfer, as described above, from the power source, e.g., EVSE 206-A, to the load, e.g., 206-A shown in FIG. 2-A, if a performance Metric is outside a safe range such as a measured temperature on an internal power line L1-L2 or power outlet A2. Adapter 210-A is typically disposed on the end of the power line, and plugged into the EV load, e.g., 230-A, which is closer to a thermal hazard in the battery of the EV load 230-A than EVSE 206-A. Thus, adapter 210-A will detect a temperature problem much quicker than EVSE 206-A, and turn off power sooner, thereby avoiding a potentially catastrophic incident.

Referring now to FIG. 6B, a flowchart 600-B is shown of a method to aggregate and manage multiple standalone adapters for load control vis-à-vis power grid real-time price and demand metrics, according to one or more embodiments.

In operation 630, load server 700 of FIG. 7 receives a status request 630-A for a status update, such as a load request or a power source option, from an adapter. In response, load server operation 632 receives a location identify input 632-A from a cellular or GPS sourced by adapter 210-A. Inquiry operation 634 determines whether charging is billed to an account other than the user. If so, then output 634-A records power consumption via metering module 222-A of FIG. 2A and transfers the billing from a 3^{rd} party to the user, by wirelessly communicating same from transceiver 223-A to load server 700, which then relays same to power generation/transmission providers 103 of FIG. 1. This scenario could arise from charging at a private residence, with no effective opportunity for the account holder to bill the user, or it could arise at a commercial EVSE. Next, optional operation 636 retrieves an adapter user's profile 309 and preferences from a database, e.g., database function 308 of FIG. 3 as implemented by a physical data storage unit 712. Alternatively, user can store her profile in local memory 233 of adapter 210-A or optionally provides that profile to load server 700 with a request to charge. In operation 638, load server 700 receives an input 638-A from grid operators of price and demand for power on the grid. Optional input 638-B of grid quality can be input to grid server from at least one adapter. In response to these inputs, load server 700 can make a determination of the quality of the power, or potential problems in the power grid prior to enabling users to charge. Operation 640 essentially repeats operation 638 to aggregate inputs from adapters into a block of power demand over a geographical area and over periods of time, and can provide 640-A output of head/unit/subgrid demand indicating the increased load on the grid at specific locations, times, etc.

Operation 642 calculates a value-based power consumption level for adapters per factors identified by both grid operators supply (cost of power), and by user demand (severity of need). In operation, the value-based power consumption level is communicated to adapter as an instruction to generate a replacement power control signals as an artificial maximum power available from the power supply to limit power consumed by load.

Operation 644 communicates value-based power consumption levels, as shown in FIG. 4, to adapter as an instruction to generate a replacement power control signal. The power control signal will then act as an artificial maximum power available from the power supply to limit power consumed by the load. Operation 644 inquires whether adapter status has been updated or if power grid price and demand has been updated. If so, then adapter 210-A provides notice to user, or implements predetermined instructions and parameter stored in memory 233.

### Computer System:

Referring now to FIG. 7, a block diagram is shown of a computer system for implementing the load server modules via the method to aggregate and manage multiple standalone adapters for load control vis-à-vis power grid real-time price and demand metrics, according to one or more embodiments. Exemplary computing device 700 includes components and functionality that can be applied to several devices in the system 100 such as a personal computer of user, mobile device 400, mobile computer, minicomputer, mainframe, load server 700, each of which are capable of executing instructions to accomplish the functions and operations described herein.

Computing device 700 includes components such as a processor 702 coupled to a memory 704, 705, and/or 712. In particular, processor 702 can be a single or multi-processor core, for processing data and instructions. Memory 704, 705, and/or 712 are used for storing and providing information, data, and instructions, including in particular computer usable volatile memory 704, e.g. random access memory (RAM), and/or computer usable non-volatile memory 705, e.g. read only memory (ROM), and/or a data storage 712, e.g., flash memory, or magnetic or optical disk or drive. Computing device 700 also includes optional inputs, such as: alphanumeric input device 708, such as: a keyboard or touch screen with alphanumeric, function keys, object driven menus; a keypad button, a microphone with voice recognition software running on a processor, or any device allowing a player to respond to an input; or an optional cursor control device 710, such as a roller ball, trackball, mouse, etc., for communicating user input information and command selections to processor 702; or an optional display device 706 coupled to bus for displaying information; and an optional input/output (I/O) device 714 for coupling system with external entities, such as a modem for enabling wired or wireless communications between system and an external network such as the Internet, a local area network (LAN), wide area network (WAN), virtual private network (VPN), etc. Coupling medium 716 of components can be any medium that communicates information, e.g., wired or wireless connections, electrical or optical, parallel or serial bus, etc.

The computing device is only one example of a suitable computing environment and is not intended to suggest any limitation as to the scope of use or functionality of the present technology. The devices can be smart devices, with sufficient processors, memory, graphics, and input/output (I/O) capabilities to operate their respective portion of the gaming software. Alternatively, clients 702-A through 702-n can be a thin client, e.g., a dumb device, which only has a capability or is only used to a capability of displaying results and accepting inputs. Neither should the computing environment be interpreted as having any dependency or requirement relating to any one or combination of components illustrated in the exemplary computing system. The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

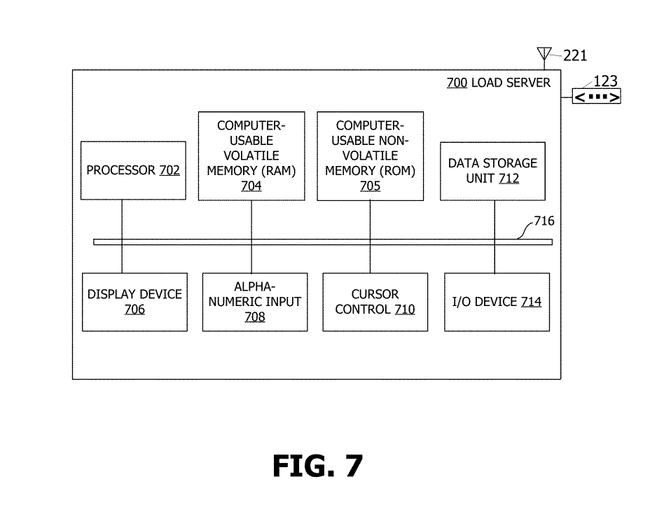

Referring now to FIG. 8, a plot 800 is shown of a geographical redistribution of power generation-consumption profiles having intra-nodal power management by the load server modules over multiple standalone adapters, according to one or more embodiments. The hypothetical baseline power consumption across different zip codes in a hypothetical city is shown as a vertical bar chart in white, while a reduction in power consumption is shown in crosshatched, and an increase in power consumption is shown in black. Given the load server's 700 ability to aggregate demand based on location, time of day, and other factors, a reduction in power consumption is possible in some zip codes, such as 94110, 94109, and 94117. This was effectuated for lowering the overall power consumption for the day, as well as reducing the load on sensitive transformers in the noted zip codes. On the other hand, power usage was allowed to increase in other zip codes that were lightly loaded, such as 94116, 94122 and 94121. Thus, power consumption can be massaged around a geographical region to add and subtract power consumption on a scale that fits the unique needs of the grid as a whole and on subnodes and subgrids as required. Again, by virtue of the bi-directional communication between load server and grid operators and the bi-directional communication between load server and load users with adapters, this present disclosure is able to provide unique input to grid management and to power consumers that will enhance the function, safety, and cost of the power grid. While power is not typically distributed solely based on zip code boundaries, this example is representative of mapping operations and power management on a subnode, subgrid basis.

Referring now to FIG. 9, a graph 900 is shown of a redistribution of power consumption based on time-of-day metrics, using the standalone adapters, according to one or more embodiments. Specifically, graph 900 contrasts baseline curve (solid) against load server managed curve (dashed) using adapters, the latter of which can optionally raise power consumption during low usage times, e.g., midnight to 10:00 am, and which can lower or flatten peak power consumption, e.g., from about 14:00 to 22:00 hours. Naturally, every application has slightly different characteristic. However, the present disclosure is as flexible as it is programmed to be and as cooperative as users of the adapter are. Overall, using the standalone adapter in conjunction with an aggregating load server provides a substantial impact on power grid operation, especially for loads that are transient and mobile.

Referring now to FIG. 10, a graph is shown of different duty cycles for generating a power control signal to manage power usage, according to one or more embodiments. The specific embodiment shown relates to the protocol for SAE J1772 charging, described above for FIG. 2A. Levels of charging ranging from maximum (MAX) down to a minimum charge level of ‘economy’, with intermediate levels of L1, L2, and L3, correspond to different duty cycles of 50%, 40%, 30%, 20%, and 10%, respectively, of a power control signal. For example, if an EVSE 206-A of Fig. A provides a power control signal C1 of ‘MAX’, but the grid, the user, or the adapter mandates the charge rate at an ‘economy’ level, then an internally generated power control signal C2 of ‘economy’ is generated by 216-C controller. This internal power control signal C2 is then switched at S2 as output as CP for the EV load 230-A. Meanwhile the EVSE power control signals C1 is sinked in the vehicle simulator 216-D. Thus, the present embodiment is able to override the EVSE 206-A seamlessly. Other duty cycles are possible in the present embodiment, such as an 80% duty cycle that is not shown. The present disclosure is capable of any regulation scheme so long as adapter 210-A is designed as such.

### Alternatives:

References to methods, operations, processes, flowcharts, systems, modules, engines, and apparatuses disclosed herein that are implementable in any means for achieving various aspects, including being carried out by a hardware circuit or a plurality of circuits (e.g., CMOS based logic circuitry), firmware, software and/or any combination of hardware, firmware, and/or software, the latter being in a form of a machine-readable medium, e.g., computer readable medium, embodying a set of instructions that, when executed by a machine such as a processor in a computer, server, etc. cause the machine to perform any of the operations or functions disclosed herein. Functions or operations may include aggregating, adjusting, assigning, calculating, coupling, communicating, controlling, comparing, discontinuing, distributing, displaying, evaluating, executing, generating, indicating, identifying intercepting, managing, maintaining, providing, receiving, regulating, replacing, retrieving, switching, sensing, storing, transferring, transmitting, and the like.

The term “machine-readable” medium includes any medium that is capable of storing, encoding, and/or carrying a set of instructions for execution by the computer or machine and that causes the computer or machine to perform any one or more of the methodologies of the various embodiments. The “machine-readable medium” shall accordingly be taken to include, but not limited to non-transitory tangible medium, such as solid-state memories, optical and magnetic media, compact disc and any other storage device that can retain or store the instructions and information. The present disclosure is also capable of implementing methods and processes described herein using transitory signals as well, e.g., electrical, optical, and other signals in any format and protocol that convey the instructions, algorithms, etc. to implement the present processes and methods. The memory device or similar electronic computing device manipulates and transforms data represented as physical (electronic) quantities within the devices' registers and memories into other data similarly represented as physical quantities within the devices' memories or registers or other such information storage, transmission, or display devices.

Exemplary computing systems, such as a personal computer, minicomputer, mainframe, server, etc. that are capable of executing instructions to accomplish any of the functions described herein include components such as a processor, e.g., single or multi-processor core, for processing data and instructions, coupled to memory for storing information, data, and instructions, where the memory can be computer usable volatile memory, e.g. random access memory (RAM), and/or computer usable non-volatile memory, e.g. read only memory (ROM), and/or data storage, e.g., a magnetic or optical disk and disk drive). Computing system also includes optional inputs, such as alphanumeric input device including alphanumeric and function keys, or cursor control device for communicating user input information and command selections to processor, an optional display device coupled to bus for displaying information, an optional input/output (I/O) device for coupling system with external entities, such as a modem for enabling wired or wireless communications between system and an external network such as, but not limited to, the Internet. Coupling of components can be accomplished by any method that communicates information, e.g., wired or wireless connections, electrical or optical, address/data bus or lines, etc.

The computing system is only one example of a suitable computing environment and is not intended to suggest any limitation as to the scope of use or functionality of the present technology. Neither should the computing environment be interpreted as having any dependency or requirement relating to any one or combination of components illustrated in the exemplary computing system. The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine-readable medium). Similarly, the modules disclosed herein may be enabled using software programming techniques. For example, the various electrical structure and methods may be embodied using transistors, logic gates, and electrical circuits (e.g., application specific integrated ASIC circuitry and/or in Digital Signal; Processor DSP circuitry).

The present disclosure is applicable to any type of network including the Internet, an intranet, and other networks such as local area network (LAN); home area network (HAN), virtual private network (VPN), campus area network (CAN), metropolitan area network (MAN), wide area network (WAN), backbone network (BN), global area network (GAN), or an interplanetary Internet. Furthermore, the type of medium can be optical, e.g., SONET, or electrical, and the protocol can be Ethernet or another proprietary protocol.

Methods and operations described herein can be in different sequences than the exemplary ones described herein, e.g., in a different order. Thus, one or more additional new operations may be inserted within the existing operations or one or more operations may be abbreviated or eliminated, according to a given application, so long as substantially the same function, way and result is obtained.

As used throughout this application, the word “may” is used in a permissive sense (i.e., meaning having the potential to), rather than the mandatory sense (i.e., meaning must). Similarly, the words “include,” “including,” and “includes” mean “including, but not limited to.”

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six, interpretation for that unit/circuit/component.

The foregoing descriptions of specific embodiments of the present disclosure have been presented for purposes of illustration and description. They are not intended to be exhaustive or to limit the invention to the precise forms disclosed. Many modifications and variations are possible in light of the above teaching without departing from the broader spirit and scope of the various embodiments. The embodiments were chosen and described in order to explain the principles of the invention and its practical application, to enable others skilled in the art to best utilize the invention and various embodiments with various modifications as are suited to the particular use contemplated. It is intended that the scope of the invention be defined by the Claims appended hereto and their equivalents.

1. An apparatus for managing power transferred between a power supply and a load, the apparatus comprising:
a power input port for receiving power from the power supply;
a power output port for transferring power from the power input port to the load via one or more internal power lines;
an output control line for communicating a power control signal to the load indicating a quantity of power available for the load; and
a power management module (“PMM”) coupled to the output control line; and wherein:
the PMM is configured to manage the output control line.

2. (canceled)

3. The apparatus of claim 1 further comprising:
a plurality of intermediate control lines, wherein each of the intermediate control lines carries a respective power control signal; and
a switch coupled to the plurality of intermediate control lines; and wherein:
the switch is configured to output onto the output control line, only one power control signal received from one of the plurality of intermediate control lines.

4. The apparatus of claim 3 further comprising:
a first intermediate control line coupled to the power supply to receive a first power control signal having a first priority level; and
a second intermediate control line coupled to the PMM to receive a second power control signal generated by the PMM and having a second priority; and wherein:
the first priority level and the second priority level can be different from each other.

5. The apparatus of claim 1 wherein the PMM comprises:
a controller coupled to a second intermediate control line; and wherein:
the PMM is configured to receive an instruction generated externally from the adapter;
the instruction indicates a desired quantity of power to be made available from the power supply to the load; and
the controller implements the instruction by generating an internal power control signal representative of the desired quantity of power to be made available for the load.

6. The apparatus of claim 1 wherein:
the PMM is configured to internally generate a replacement power control signal as an artificial maximum power available from the power supply to match the instruction based upon a demand/response signal of a power grid to which the power supply is coupled.

7. (canceled)

8. The apparatus of claim 4 wherein the switch is configured to:
receive an instruction to bypass the PMM and to pass-through the first power control signal from the first intermediate control line to the load.

9. The apparatus of claim 1 further comprising:
an ammeter coupled to the internal power line to measure current consumed over a given period of time.

10. The apparatus of claim 1 further comprising:
a transceiver coupled to the PMM; and wherein:
the wireless transceiver is configured to communicate status data between the apparatus and an external node and to receive an instruction from the external node to regulate the output control line.

11. The apparatus of claim 1 further comprising:
a telemetry module for identifying a location of the adapter.

12. The apparatus of claim 1 further comprising:
a safety module coupled to the PMM; and wherein:
the safety module is configured to:
evaluate one or more performance metrics; and
disable the power source if a performance metric is outside a safe range or level.

13. The apparatus of claim 1 further comprising:
a temperature meter coupled to the PMM; and wherein:
the temperature meter measures a temperature of at least one of an internal power line, a power inlet and a power outlet.

14. The apparatus of claim 1 further comprising:
a power quality module; and wherein:
the power quality module senses a quality level of at least one of a current and a voltage of the power received from the power supply;
the power quality module communicates the quality level to the PMM; and
the PMM adjusts a second power control signal based on the quality level.

15. The apparatus of claim 14 wherein:
the power quality module reduces power consumption if the quality level indicates an overload of a local distribution transformer.

16. A system for managing power, the system comprising:
a load server coupled to a power grid, wherein the load server comprises:
a communication interface coupled to a communication network;
a grid power module configured to receive data on one more predicted power needs of the power grid;
a user management module configured to generate an instruction for power consumption to one or more power consumer coupled to the power grid; and
a database coupled to the communication interface, the grid power module, and the user management module; and wherein:
the load server is configured to transmit the instruction for power consumption to one or more power management module (“PMM”) coupled to one or more loads; and
the PMM is configured to manage an output control line indicating a quantity of power available for the load.

17. (canceled)

18. The system of claim 16 wherein the load server is further configured to:
receive location information and a power need from the power consumer coupled to the power grid.

19. The system of claim 18 wherein the load server is further configured to:
map the location information and the power need from the one or more power consumers to one or more topology nodes in a power distribution network of the power grid; and
regulate the one or more loads on the power grid by transmitting the instruction on power consumption to the power consumer.

20. (canceled)

21. The system of claim 1 wherein the load server is further configured to:
aggregate the quality level and power needs for each of the one or more power consumers based on a topology node or a power distribution network.

22. The system of claim 18 wherein the load server is further configured to:
predict power consumption needs based on the location information; and
adjust instructions for power consumption proactively for the power grid.

23. (canceled)

24. (canceled)

25. A method of managing power to be transferred between a power supply and a load, the method comprising:
receiving power from the power supply at a power input port of an adapter;
transferring power from the power input port to a power output port via one or more internal power lines;
receiving and communicating a power control signal to the load via an output control line, wherein the power control signal indicates a quantity of power available for the load; and
managing the power control signal via a power management module (“PMM”) coupled to the output control line that can modify the power control signal provided to the output control line.

26. (canceled)

27. The method of claim 25 further comprising:
communicating one of a plurality of power control signals on each of plurality of intermediate control lines, wherein the plurality of control lines are coupled to a switch; and
selectively switching between the plurality of intermediate control lines to communicate a given one of the plurality of power control signals to the output control line via a switch coupled to the plurality of supply control lines.

28. (canceled)

29. (canceled)

30. (canceled)

31. (canceled)

32. (canceled)

33. (canceled)

34. (canceled)

35. (canceled)

36. (canceled)

37. (canceled)

38. (canceled)
